(19) United States
(12) Patent Application Publication
(10) Pub. No.: US 2021/0061682 A1
(43) Pub. Date: Mar. 4, 2021

(54) Dual-Channel Double-Electrode Cache Device for Continous Deionization of High Salinity Waters

(71) Applicant: Derrick George Noe, Meerbusch (DE)

(72) Inventor: Derrick George Noe, Meerbusch (DE)

(73) Assignee: Derrick George Noe

(21) Appl. No.: 16/559,743

(22) Filed: Sep. 4, 2019

(51) Int. Cl. C02F 1/469

(52) U.S. Cl. CPC C02F 1/4691; C02F 2101/12; C02F 2201/46

(57) ABSTRACT

Originally observed in 1960 by Blair and Murphy, Capacitive Deionization Technology (CDI) is based on ion electroabsorption at the surface of a pair of electrically charged electrodes, commonly composed of highly porous carbon materials. Recent advances in cell architectures and systems designs have yet to result in an economically viable, industrial-scale device to efficiently desalinate high salinity waters. The limiting factors thus far not solved are 1) surface requirements, 2) time inefficiencies inherent to charge-discharge cycles, 3) brine stream and feed water stream fluidic handling and 4) ecological managment of the residual brine stream.

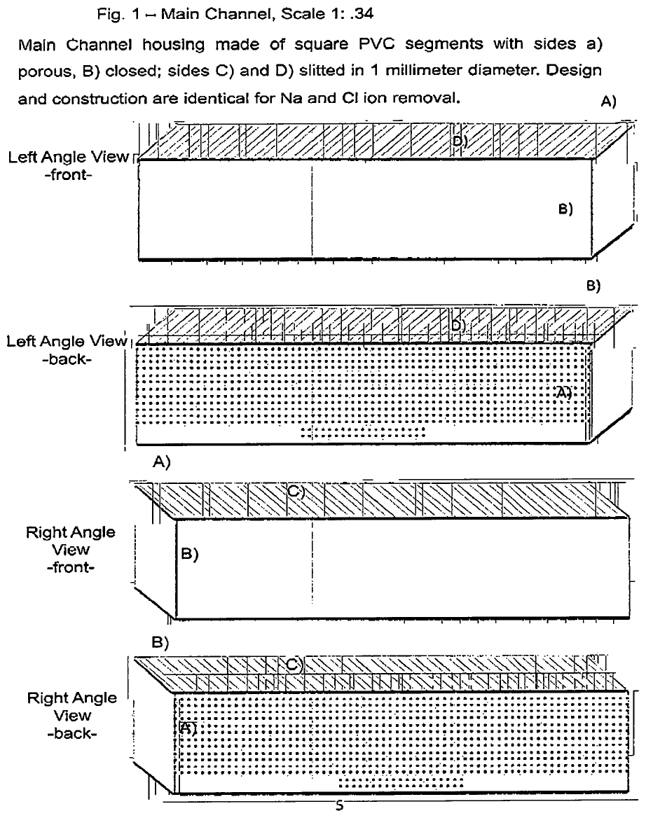

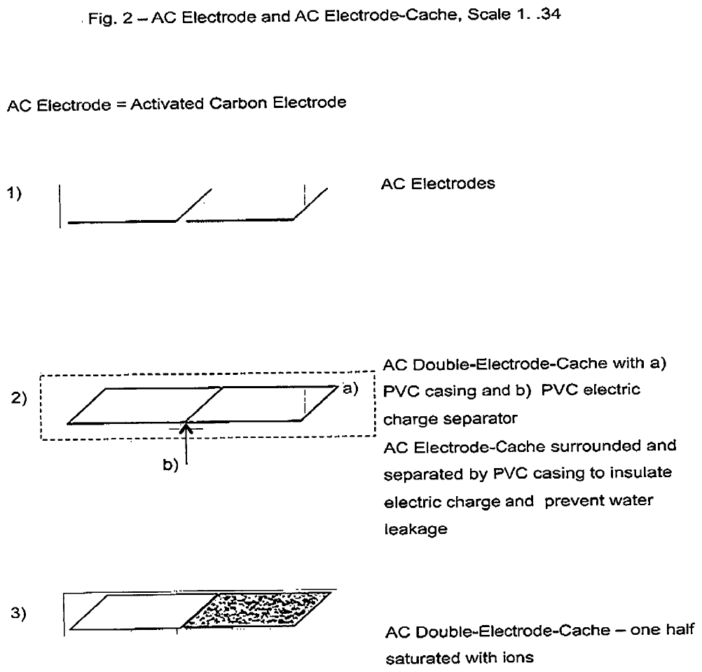

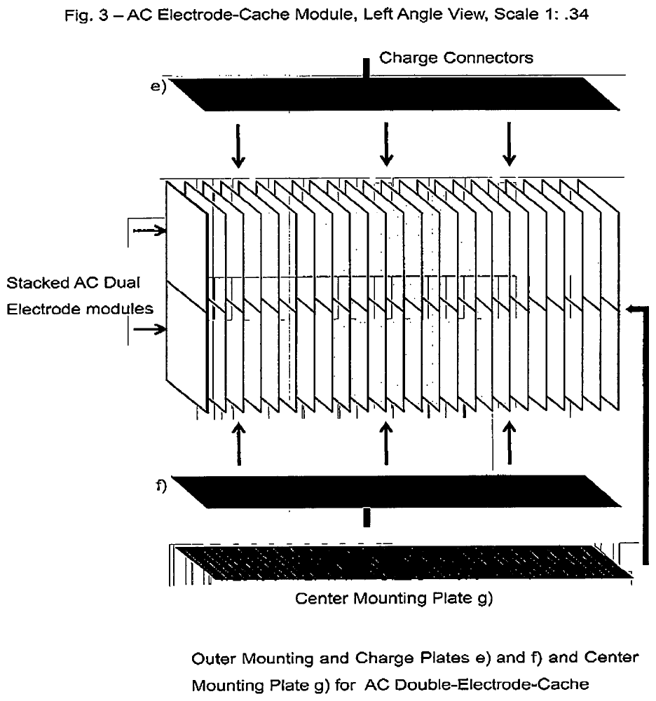

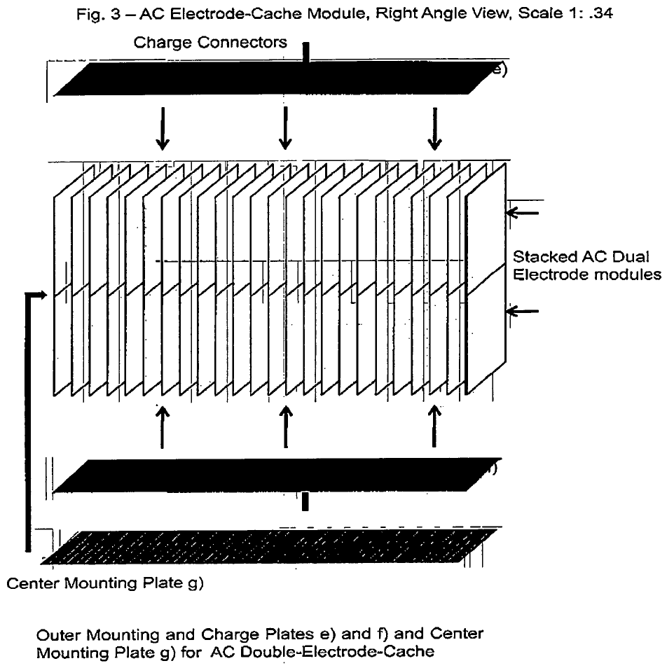

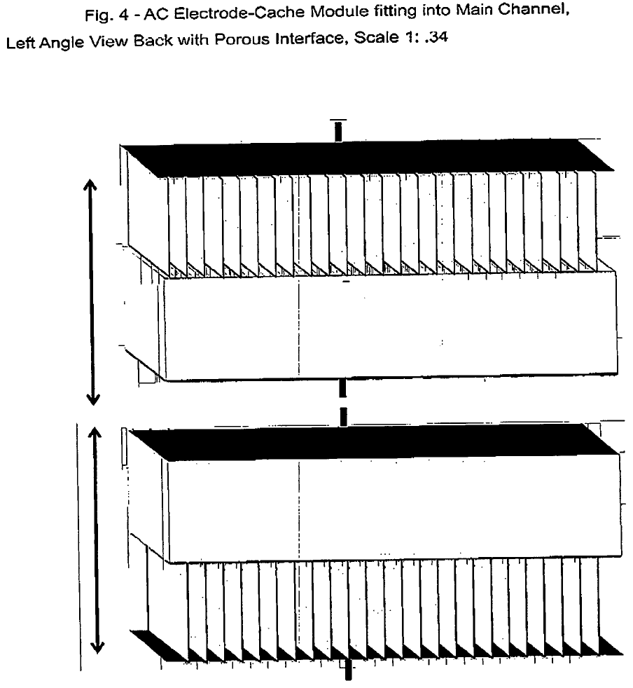

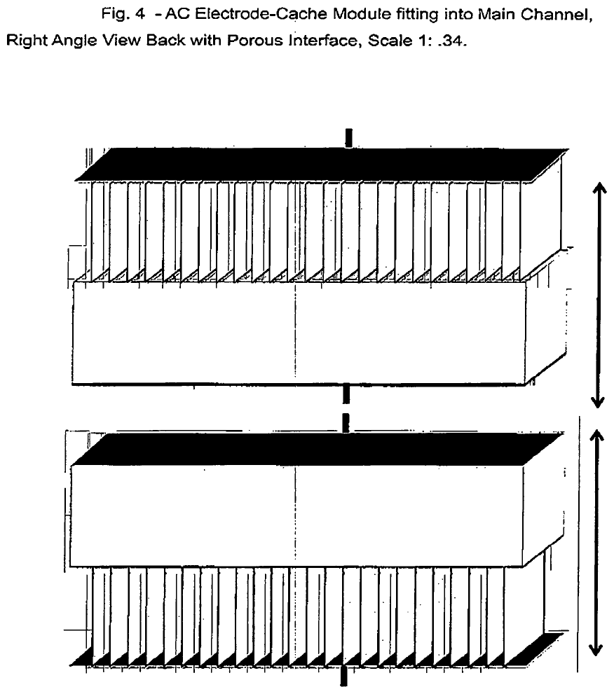

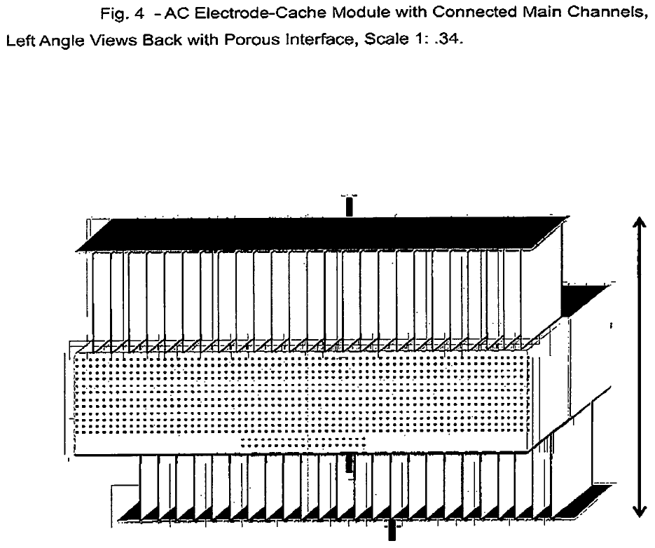

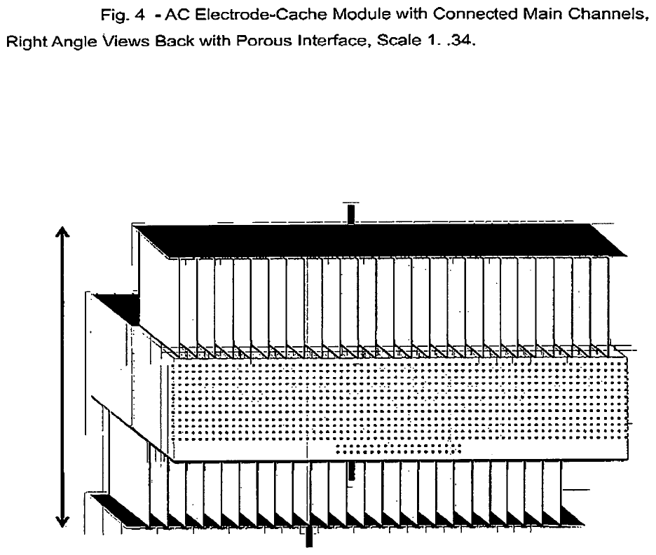

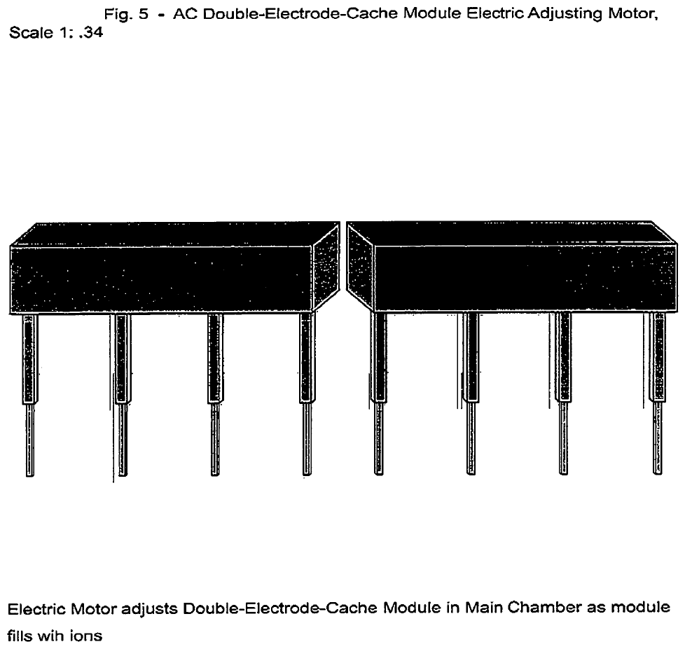

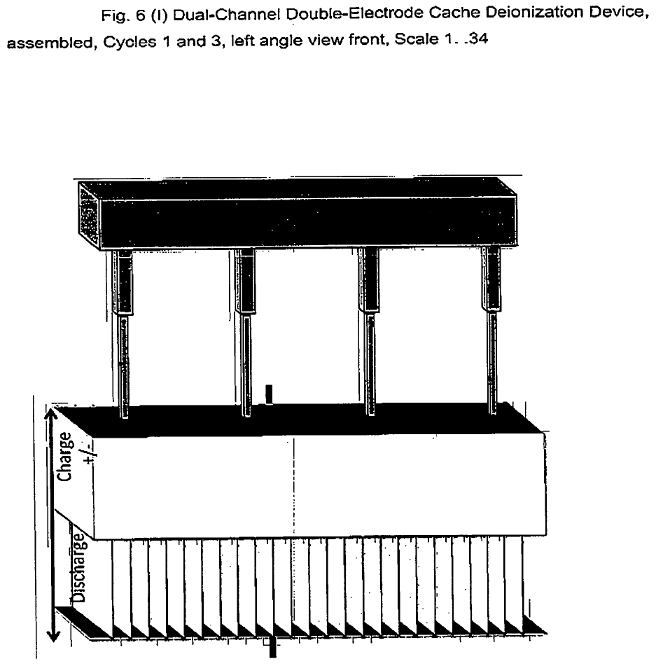

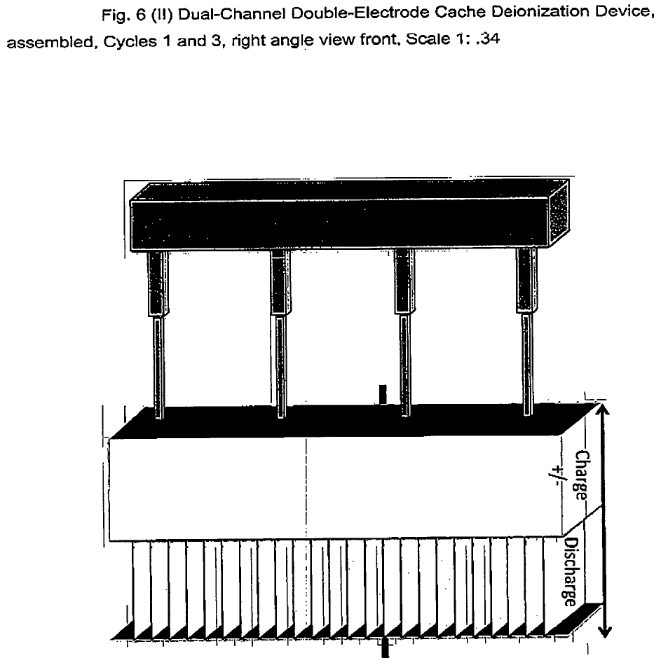

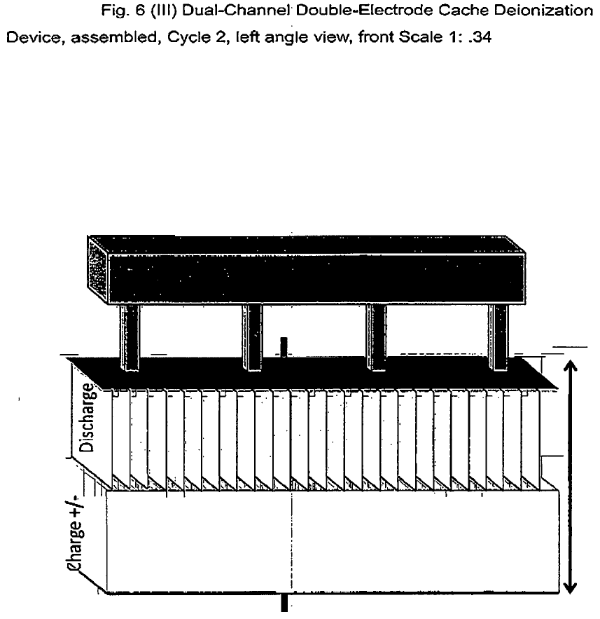

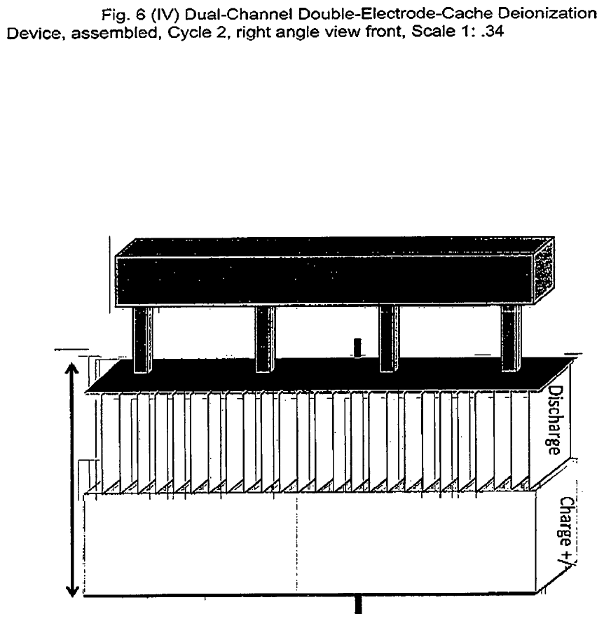

Conventional CDI devices with flow-by or flow-through electrode architectures, including membrane supported structures, operate on the principle that the electrosorption process and fluidic handling within one channel ultimately lead to two distinct streams at the end of the desalination process, a freshwater stream and a residual brine stream with a very high concentration of ions.

The Dual-Channel Double-Electrode Cache Deionization Device does not have one residual brine stream with a very high concentration of sodium and chlorine ions. The residual products, Sodium cations (Na) and Chlorine anions (Cl), are each removed in separate channels. The architecture and operating modus are such that instead of one channel two channels, connected with a porous interface to ensure ion migration between the channels, operate simultaneously, each with the sole purpose of removing only one type of ion. Within each channel double-electrode-cache modules, identical in design and operation, attract each ion type with a positive. resp. negative electric charge of between 0.8 V and 1.4 V, each cache consisting of two electrodes which are electrically isolated from each other.

DUAL-CHANNEL DOUBLE-ELECTRODE-CACHE DEIONIZATION DEVICE FOR HIGH SALINITY WATERS—ELECTRODE ARCHITECTURE (I)

DUAL-CHANNEL STACKED DOUBLE-ELECTRODE-CACHE DEIONIZATION DEVICE FOR HIGH SALINITY WATERS—ELECTRODE ARCHITECTURE (II)

DESCRIPTION OF ELECTRODE ARCHTITECTURES ON PGS. 2 AND 3

1) Brief description of electrode archtictures in existing models (no drawings enclosed):

In flow-by architecture, two electrodes are placed parallel to each other in one channel in such a way that a small planar gap is left in between the electrodes through which water flows parallel to the electrodes, ions being attracted to positive and negative electric charges.

In flow-through applications, he device pumps water perpendicular to the layered structure, typically consisting of (alternating) positively and negatively charged electrodes within one channel.

Electrostatic ion pumping involves semi-continously two separate streams being produced from different exit points, within one channel: a freshwater stream from one end of the device and a concentrate stream from the other end. In movable carbon rod electrode architectures, electrodes apply a voltage difference between the anode and cathode wires, attracting ions into their counter electrodes. Once saturated, the wires are moved from the single channel for the discharging step into a separate second channel.

In all four existing electrode architecture models, seawater deionization is attempted in just one water channel, with significant time losses resulting from charge-discharging cycles of the electrodes, and with the residual element after deionization being common salt.

Description of the Dual-Channel Double-Electrode-Cache Deionization Device for High Salinity Waters

Each channel is dedicated to removing only one ion type. The interface between both channels is porous thus allowing free movement and permanent exchange of ions between both channels.

The device operates with a double electrode-cache, each cache being comprosed of two activated carbon (AC) electrodes, which are electrically isolated from each other. The caches are stacked within a module, the half inside the main channel being electrically charged. The half outside the main channel is in cycle one not charged and in cycles two and three in discharge modus. Once the cache half inside the main channel become saturated with ions, an electric motor adjusts the cache module so that the saturated half of the cache leaves the main channel and the non-saturated half slides into the channel. The saturated half goes into discharge mode by reversing ist charge while the previously non-charged half becomes charged and begins attracting ions. Once Na and Cl ions have been sufficiently removed in separate channels, the water streams are redirected into opposite channels where the process continues until the desired residual ion concentrations are reached. Both channels are identical in design and operation.

Description of Device Operation, Left Angle View Single Channel, FIG. I a, Cycle 1 Na/Cl Electrosorption, Scale 1:0.34

Description of Device Operation, Left Angle View Double Channel, FIG. I a, Cycle 1 Na and Cl Continous Electrosorption, Scale 1:0.34

Description of Device Operation, Left Angle View Single Channel, FIG. II a, Cycle 2 Na/Cl Electrosorption, Scale 1:0.34

Description of Device Operation, Left Angle View Double Channel, FIG. II a, Cycle 2 Na and Cl Continous Electrosorption, Scale 1:0.34

4. Description of Device Operation, Left Angle View Single Channel, FIG. III a, Cycle 3 Na/CL Electrosorption, Scale 1:0.34

Description of Device Operation, Left Angle View Double Channel, FIG. III a, Cycle 3 Na and Cl Continous Electrosorption, Scale 1:0.34

Dual-Channel Double-Electrode Cache Deionization Device, Description of Device Operation

The device is fully scalable, for instance with respect to the dimensions of the individual components, the number and length of individual main channels that can be connected to each other or the spacing between the activated carbon electrode-caches. In this model a scale of 1:0.34 is used, the electrodes have a thickness of 500 micrometers and are spaced 1.0 millimeters apart. The main channels are contructed of PVC, the electric adjusting motors are standard off-the-shelf products. All mounting plates are made of copper/copper alloy to facilitate transmission of the electric charge and resist corrosion by seawater. The device operates with direct current and 0.8 V-1.4V. Unlike existing CDI terminology, this model does not refer to a cycle consisting of a charging and a discharging step, but rather, of three distinct cycles. The design and operation of both channels are identical.

The operating principle of the device is identical to all known CDI architectures: As brine solution flows through activated carbon electrode-caches, the positively charged sodium cations are attracted to a negative electric charge, while the negatively charged chlorine anions are attracted to a positive electric charge, the charge cycle. Once the electrode material is saturated it must be discharged so that the electrodes may be separated from the ions, the discharge cycle, in which charge is reversed.

The unique Dual-Channel Stacked Electrode-Cache Deionization Device overcomes the limitations of all known seawater deionization architectures, a) surface-to-water inefficiencies, b) fluidic handling for brine solution and deionized water, c) charge-discharge time loss and d) variability and scalability of the deionization process.

Dual-Channel Double-Electrode Cache Deionization Device, Description of Device Operation

At the outset of cycle 1 (drawings pgs 6&7), seawater flows into the main channel and through stacked AC electrode-cache modules (flow-through mode). The modules consist of stacked AC electrode-caches connected to mounting plates that can be adjusted within the main channel and that conduct the electric charge. The cache consists of two AC electrodes which are electrically isolated from each other.

As cycle 1 begins, the AC electrode-cache half inside the main channel is electrically charged, the half outside of the channel is not. As flow progresses, AC electrode-caches within the main channel become saturated with ions. When peak saturation capacity is reached, the AC electrode-cache modules must be adjusted for cycle 2.

In the first combined charge-discharge cycle, cycle 2 (drawings pgs. 8&9), AC Electrode-Cache Module Electric Adjusting Motor adjusts ion saturated AC Electrode-cache modules in the main channel, so that the on saturated cache halfs are removed from the main channel, reversing their electric charge and beginning the discharge mode. Simultaneously, non-saturated cache halfs in the electrode module are moved into the main channel. They then become charged and begin attracting ions. As flow progresses, AC electrode-caches within the main channel become saturated with ions. When peak saturation capacity is reached, the AC electrode-cache modules must be adjusted for cycle 3 (drawings pgs. 10&11).

Dual-Channel Double-Electrod-Cache Deionization Device, Description of Device Operation

In the third charge-discharge cycle, AC Electrode Module Chamber Adjusting Motor again removes the ion saturated cache half out of the main channel. The sliding electrode module replaces the saturated electrode-cache half with the opposite side electrode-cache half, which becomes charged and begins attracting ons. The ion-saturated electrodes reverse charge simultaneously.

The residual products, Sodium cations (Na) and Chlorine anions (Cl), are each removed in separate channels, with a porous interface connecting both channels to ensure free exchange of ions and therefore charge neutrality. During the process of continous ion removal, Ions will migrate between both channels, continously adapting to lower ion concentrations in both channels and remaining in a 1:1 equilibrium, albeit on continously reducing levels.

Final Na and Cl ion concentrations, depending on the intended water usage i.e. industrial, agricultural, potable, are completely variable.

1. The densely stacked electrode-cache architecture maximises electrode surface to water ratio and flow-through deionization time efficiency, thereby significantly reducing time requirements for the deionization process, simultaneously complex fluidic handling is completely eliminated.
The Double Electrode-Cache Module charges one half of the cache within the main channel. The half of the cache outside of the main channel is not charged. Once cycle 1 of the electrosorption process is completed, the ion-saturated half of the cache is removed from the main channel and begins discharging. Simultaneously, the opposite half of the cache moves into the main channel, becomes charged and begins attracting ions. The electrode-cache transfers in-and-out of the main channel; the discharging cycle does not interrupt or inhibit the charging cycle, each side of the electrode-cache is nearly in a permanent discharge or charge order. In all known CDI devices the charging step is interrupted by the discharging step. The device eliminates the time loss associated with conventional CDI architectures, which operate with sequential charge-discharge cycles, with a charging time loss of approx. 50%. The device operates with permanent charging cycles (Cycles 1,2,3) and permanent discharging cycles (Cycles 2,3). By combining two electrodes which are electrically isolated from each other in one adjustable cache, a constant charge-discharge modus between the two electrodes inside and outside of the main channel is enabled.

2. The Dual-Channel Deionization Device deionizes brine stream by electrosorption of only one ion (Na or CL) per channel, two channels being in operation simultaneously, therefore completely eliminating the complicated fluidic handling inherent to all known CDI architectures, which operate with only one channel in which ion removal (charging cycle) and ion elimination (discharging cycle) occur sequentially.

2. The Dual-Channel Deionization Device deionizes brine stream by electrosorption of only one ion (Na or CL) per channel, two channels being in operation simultaneously, therefore completely eliminating the complicated fluidic handling inherent to all known CDI architectures, which operate with only one channel in which ion removal (charging cycle) and ion elimination (discharging cycle) occur sequentially.

3. The dual channel device removes a) positively charged sodium cations in the negatively charged double-electrode cache, and, b) negatively charged chlorine anions are removed in the positively charged double-electrode cache. The residual bi-products are sodium and chlorine. The separation of water from brine elements Na and Cl occurs without a further fluidic handling process. The architecture and operating modus effectively seperates seawater into desalinated water and a) sodium resp. b) chlorine. No known device operates on the basis of removing residual Na and Cl each in separate channels.

4. The dual-channel system systematically and sequentially removes one ion type per channel in a simplified process until the desired level of deionization is achieved, allowing variable final Na and Cl residual concentrations depending on the targeted deionization of the brine stream, which will vary depending on the final targeted usage of the deionized water (industrial, agricultural, potable in varying degrees). Due to its unique architecture and operating modus, the dual-channel double-cache-electrode deionization device allows for complete variability and scalability of the final concentrations of residual Na and Cl ions during and after completion of the deionization process

4. The dual-channel system systematically and sequentially removes one ion type per channel in a simplified process until the desired level of deionization is achieved, allowing variable final Na and Cl residual concentrations depending on the targeted deionization of the brine stream, which will vary depending on the final targeted usage of the deionized water (industrial, agricultural, potable in varying degrees). Due to its unique architecture and operating modus, the dual-channel double-cache-electrode deionization device allows for complete variability and scalability of the final concentrations of residual Na and Cl ions during and after completion of the deionization process.
No known device operates with such variability of Na and Cl residual values, as common CDI modes of operation are designed on the principle of complete removal of both residual products in one stream.

5. The Dual-Channel Stacked Double-Electrode-Cache Deionization Device operates with three steps which are referred to as independent cycles: 1) An initial charging of the double-electrode cache electrode inside the channel: 2) Thereafter, the initially charged double-electrode cache reverses the charge outside the main channel while simultaneously the double-electrode cache which has moved inside the main channel charges: 3), cycle 2 is repeated, the saturated double-electrode cache inside the main channel reversing charge after being removed from the main channel for the first time.
